(19) United States
(12) Patent Application Publication
(10) Pub. No.: US 2004/0203371 A1
(43) Pub. Date: Oct. 14, 2004

(54) Error control in a bluetooth wireless communication system

(75) Inventors: Weng Wah Loh, Filton (GB); John Deryk Waters, (US)

Correspondence Address: HEWLETT-PACKARD COMPANY, Intellectual Property Administration, P.O. Box 272400, Fort Collins, CO, 80527-2400, US

(73) Assignee: HEWLETT PACKARD COMPANY

(21) Appl. No.: 10/265,676

(22) Filed: Oct. 8, 2002

(51) Int. Cl. H04B 5/00; H04B 17/00

(52) U.S. Cl. 455/41.2; 455/226.1

(57) ABSTRACT

Devices of a Bluetooth wireless communication system are adapted to include an L2CAP extension layer that calculates error control data for each packet of payload data. An error control data packet is transmitted immediately following each packet of payload data. The L2CAP extension layer checks incoming payload data packets using the associated error control data, to determine transmission errors such as caused by radio-frequency interference. A preferred example uses 32-bit Ethernet to generate an error control checksum, providing robust error checking for a high integrity transmission link such as between a computing device and a printer.

The present invention relates in general to a method for controlling errors in a Bluetooth wireless communication system, and to a Bluetooth wireless communication system that employs error control.

A specification of the Bluetooth wireless communication system is published at www.bluetooth.org. See version 1.1, dated 22 Feb. 2001, particularly section B.5 on pages 66-75. Bluetooth is a trade mark of Bluetooth SIG, Inc.

The Bluetooth wireless communication system allows high-speed radio-frequency communications between a wide variety of devices. In particular, communications links are established that allow data transmission between a transmit device and a receive device, which each form part of a local network or piconet. Although generally reliable, data transmissions between devices may become corrupted, for example due to wireless interference. Hence, it is desired to check for the occurrence of errors during data transmission.

The Bluetooth specification version 1.1 discloses that packets of data in a baseband layer are provided with a 16-bit CRC (Cyclic Redundancy Check) checksum that is used by a receive device to check the integrity of received baseband packets. However, a problem arises in that the 16-bit checksum appended to baseband packets is not sufficiently robust for some practical applications. Here, it has been found that, despite the presence of a checksum in the baseband packets, it is still possible that errors occur which remain undetected. Undetected errors are particularly problematic, and in extreme cases may cause a receive device to seriously malfunction.

A further limitation arises in that it is desired to avoid fundamental changes to the existing Bluetooth specification version 1.1, in order to maintain compatibility with devices and applications that have been created according to that specification.

An aim of the present invention is to provide a method and apparatus that allows improved error control in a Bluetooth wireless communication system, in particular to allow more robust error checking such that fewer errors remain undetected. A preferred aim is to provide improved error checking in a Bluetooth wireless communication system, whilst maintaining compatibility with existing devices and applications.

According to a first aspect of the present invention there is provided an error control method for use in a Bluetooth wireless communication system that includes a transmit device and a receive device, the transmit device and the receive device each comprising an application layer, an L2CAP extension layer, an L2CAP layer, and one or more lower layers, the method comprising the steps of: in the transmit device, receiving payload data from the application layer at the L2CAP extension layer; calculating an error control data from the payload data; and passing the payload data and the error control data to the L2CAP layer for transmission to the receive device; and, in the receive device, receiving the payload data and the error control data at the L2CAP layer; checking the received payload data using the received error control data in the L2CAP extension layer; and passing the checked payload data to the application layer.

The error control data suitably comprises a CRC (cyclic redundancy check) checksum. Preferably, the error control data is discarded in the L2CAP extension layer, such that the error control data is not passed to the application layer of the receive device.

Preferably, the method comprises, in the transmit device, forming a payload data packet containing payload data received from the application layer; and forming an associated error control data packet containing error control data calculated from the payload data in the payload data packet. Suitably, the payload data packet is transmitted immediately followed by the error control data packet.

Preferably, the method comprises the step of negotiating between the transmit device and the receive device, or vice versa, to establish either a normal mode of operation without the calculation of error control data, or a high integrity mode of operation that includes calculation of error control data.

Preferably, the method comprises the step of taking remedial action if no error control data is received at the receive device, or if checking the payload data using the received error control data indicates an error in the payload data.

According to a second aspect of the present invention there is provided a method of providing a high integrity link in a Bluetooth wireless communication system, the method comprising the steps of: negotiating a high integrity mode between a transmit apparatus and a receive apparatus; receiving payload data from an application layer into an L2CAP extension layer, calculating a checksum, and transmitting the checksum and the payload data; and receiving the payload data and the checksum at an L2CAP extension layer, checking the payload data using the checksum, and passing the payload data to an application layer.

Here, the method preferably comprises forming a first L2CAP data packet that contains the payload data, and forming a second L2CAP data packet that contains the checksum. Ideally, the method comprises transmitting the second L2CAP data packet containing the checksum immediately following the first L2CAP data packet containing the payload data. Also, the method preferably comprises discarding the second L2CAP data packet containing the check sum, once the received payload data has been checked.

According to a third aspect of the present invention there is provided a Bluetooth wireless communication system, comprising: a transmit device having an application layer and an L2CAP layer, and an L2CAP extension layer between the application layer and the L2CAP layer, the L2CAP extension layer being arranged to calculate error control data from payload data; and a receive device having an application layer and an L2CAP layer, and an L2CAP extension layer between the application layer and the L2CAP layer, the L2CAP extension layer of the receive device being arranged to check received payload data using received error control data.

Preferably, the transmit device is arranged to form a first L2CAP data packet containing the payload data, and a second L2CAP data packet containing an error control checksum. Preferably, the transmit device is arranged to transmit the first L2CAP data packet containing the payload data immediately followed by the second L2CAP data packet containing the checksum. Preferably, the receive device is arranged to discard the error control data in the L2CAP extension layer, such that only the payload data is passed to the application layer. Preferably, the receive device is arranged to take remedial action if the error control data is not received, or if the error control data indicates an error in the received payload data.

According to a fourth aspect of the present invention there is provided a device adapted for use in a Bluetooth wireless communication system, the device comprising: an application layer; an L2CAP layer; and an L2CAP extension layer between the application layer and the L2CAP layer, the L2CAP extension layer being arranged to form a checksum from payload data received from the application layer for transmission through the L2CAP layer, and being arranged to check payload data received from the L2CAP layer using received checksum data before passing the received payload data to the application layer.

For a better understanding of the invention, and to show how embodiments of the same may be carried into effect, reference will now be made, by way of example, to the accompanying diagrammatic drawings in which:

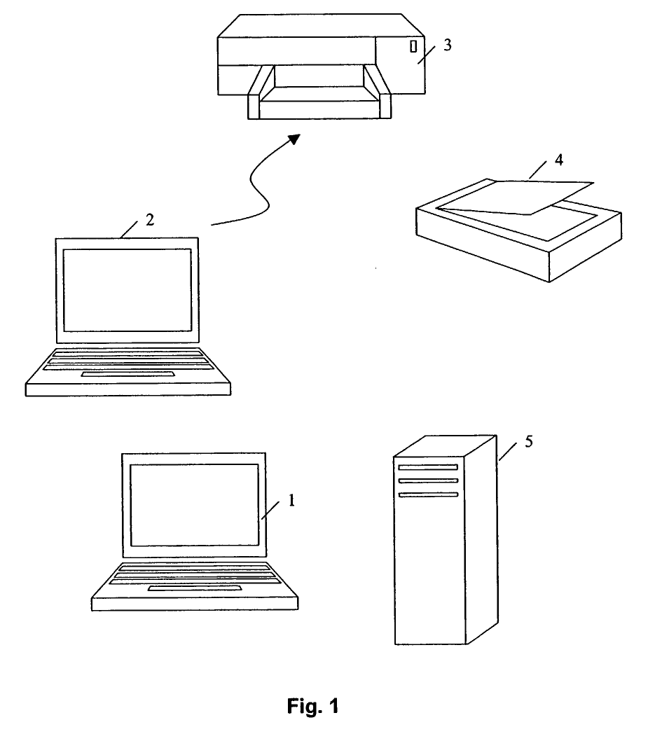

FIG. 1 is a schematic overview of a Bluetooth wireless communication system;

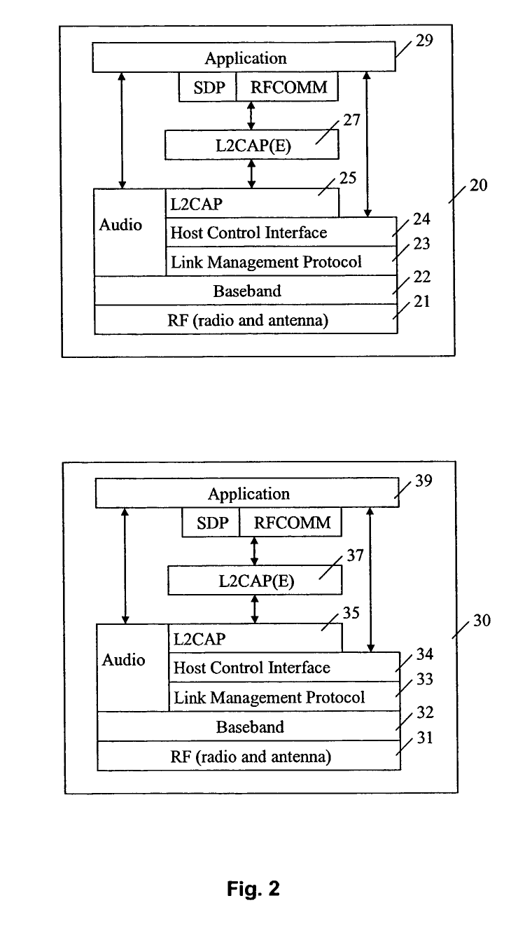

FIG. 2 is a schematic diagram of a protocol stack in a transmit device and in a receive device of a Bluetooth wireless communication system according to a preferred embodiment of the present invention;

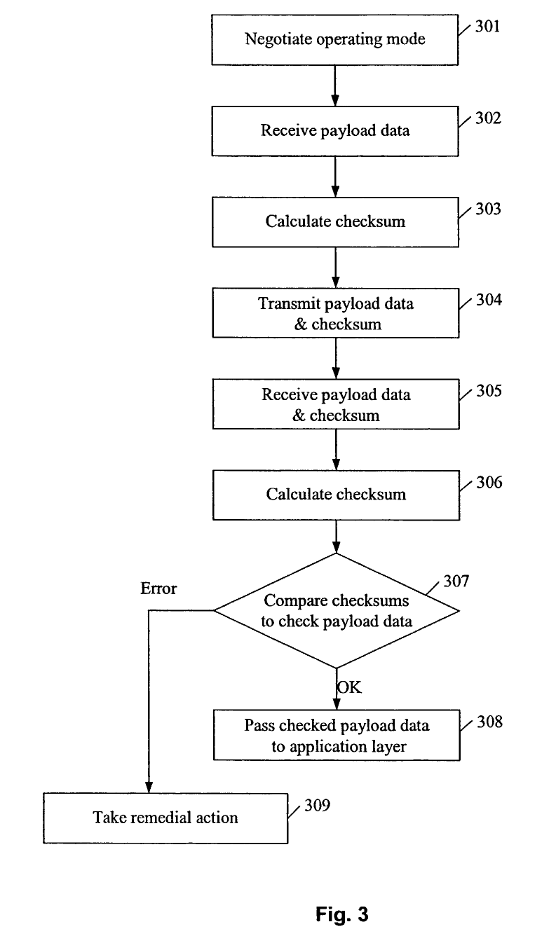

FIG. 3 is a schematic flow diagram illustrating a preferred error control method; and

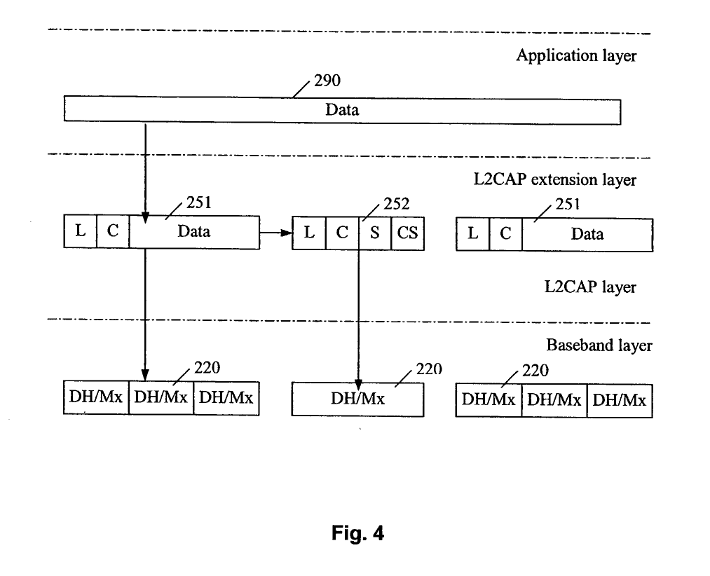

FIG. 4 is a schematic diagram showing data in protocol stack layers of a system according to a preferred embodiment of the invention.

Referring to FIG. 1, a preferred Bluetooth wireless communication system is shown, comprising a plurality of devices 1-5. The devices 1-5 form a piconet, with one of the devices designated as a master and other devices designated as slaves. In this example, it is desired to transmit data from a transmit device 2 to a receive device 3. Conveniently, the transmit device 2 is the master, and the receive device 3 is one of the slaves. However, other configurations are also possible, such as communications between peer slave devices 2,3 through a separate master device 1. The transmit device 2 is suitably a general purpose computing device such as a desktop personal computer, a laptop or notebook computer, or a personal digital assistant (PDA). Meanwhile, the receive device 3 is suitably an output device such as a printer.

Although data transmission within the Bluetooth wireless communication system is generally reliable, unfortunately it has been found that transmission errors occasionally do occur and, more importantly, may go undetected. A data transmission error may, for example, cause the receive device 3 to malfunction, such as a printer producing unnecessary page feeds or printing garbage data. Following such an error, it is usually necessary to disconnect a transmission link established between the devices, causing a delay and inconvenience for a user.

FIG. 2 shows a protocol stack 20, 30 as employed by the transmit and receive devices 2, 3 respectively, according to a preferred embodiment of the present invention.

Lower layers of the transmit device protocol stack 20 include a radio frequency (RF) layer 21, a baseband layer 22, a link management protocol (LMP) layer 23, and a host control interface (HCI) 24.

The RF layer 21 forms a physical connection between the devices, using radio frequency transmissions of about 2.4 GHz. The baseband layer 22 controls the RF layer, including synchronising clocks between devices and establishing connections. Data in the baseband layer is transmitted as baseband packets, which have a length of up to 2745 bits as defined in the Bluetooth specification. A simple form of error correction is provided in the baseband layer 22, by including a 16-bit checksum in each baseband data packet. Various packet types are specified for common applications, which differ in their data capacity and error correction overheads. Also, five different channel types are provided in the baseband layer for control information, link management information, user synchronous data, user asynchronous data, and isynchronous data. In particular, the baseband layer allows two main types of data link to be established, namely SCO (Synchronous Connection-Oriented) links for synchronous data such as voice data, and ACL (Asynchronous Connection-Less) links for data transfer applications which do not require a synchronous link, such as data transfer between a computing device and a printer.

The LMP layer 23 controls piconet management, link configuration and security functions. Usually, the LMP layer 23, the baseband layer 22, and the RF layer 21 are implemented as hardware or firmware.

Above these hardware and firmware layers 21-23 lies a host controller interface 24 that provides logical connections and data transfer to the physical hardware modules of the lower layers. The host controller interface typically includes a HCI driver for physically controlling the hardware elements of the lower layers, according to the construction of a particular host device.

A L2CAP (Logical Link Control and Adaptation Protocol) layer 25 provides a logical interface between the lower mainly hardware implemented layers 21-24, and higher typically software implemented layers including an application layer 29. In particular, the L2CAP layer 25 performs segmentation and reassembly of payload data. During transmission, the L2CAP layer 25 accepts packets of payload data of a size up to 64 kb, and segments the payload data into baseband packets of a size at most 2745 bits. The reverse procedure of reassembling baseband packets into the proper order to recreate original payload data is carried out when receiving data. The L2CAP layer 25 provides other functions such as quality of service (QoS) on certain parameters such as peak bandwidth, latency and delay variation, and provides channel multiplexing to allow multiple applications to use a single physical link between two devices.

The application layer 29 contains one or more higher-level applications, which interact with the L2CAP layer 25 to transmit and receive data over the Bluetooth wireless communication network. These applications may take any suitable form, and are tailored to the operating environment of a particular host device 2, 3, such as a PC or printer. The applications in the application layer 29 are written to interact with the L2CAP layer 25, and expect the L2CAP layer 25 to operate according to the Bluetooth specification.

An equivalent protocol stack 30 is provided in the receive device 3, including an application layer 39, a L2CAP layer 35, and lower layers 31-34.

As shown in FIG. 2, in the preferred embodiment of the present invention, both the transmit device 2 and the receive device 3 include an extension of the L2CAP layer 25, 35. That is, the transmit device 2 includes an L2CAP extension layer 27, and the receive device 3 includes an L2CAP extension layer 37.

In the transmission device 2, payload data is sent from the application layer 29 to the L2CAP layer 25 through the L2CAP extension layer 27. Similarly, in the receive device 3, payload data received from the L2CAP layer 35 is passed to the application layer 39 through the L2CAP extension layer 37. When the extension layer 27, 37 is present in both the transmit device 2 and the receive devices 3, then the devices may enter a high-integrity mode with improved error control. If no extension layer 27, 37 is present, or if the extension layer is present in only one of the devices 2, 3, then the devices operate in a normal mode without improved error control.

Briefly, improved error control is obtained by creating additional error control data packets in the L2CAP extension layer 27 of the transmit device 2. Each packet of payload data sent through the L2CAP layer 25 of the transmit device 2 is followed by an error control data packet, containing error control data (e.g. a checksum) calculated from the payload data. The L2CAP extension layer 37 of the receive device 3 checks the payload data in each payload data packet, using the checksum in the associated error control data packet.

The L2CAP extension layer 27, 37 is readily implemented as an adaptation to devices constructed according to the Bluetooth specification version 1.1. In the preferred embodiment, the extension layer 27, 37 is transparent to the software applications of the upper application layer 29, 39 by maintaining the existing L2CAP interface. Also, the L2CAP extension is transparent to the lower layers of the host device 21-25, 31-35, which operate according to the existing specification version 1.1. Suitably, the L2CAP extension layer 27, 37 is implemented as a software patch.

FIG. 3 is a schematic flow diagram showing an overview of the preferred error control method. Operation of the transmit device 2 and the receive device 3 will now be described in more detail, with reference to the flow diagram of FIG. 3.

Step 301 comprises negotiating either a normal mode or a high integrity mode. Typically, negotiation is initialised by the transmit device 2, by sending a configuration request to the receive device 3 requesting a high integrity link. The configuration request advantageously makes use of a standard configuration request procedure defined in the Bluetooth specification, i.e. sending an L2CA_ConfigReq message. The configuration request message contains parameters that are meaningless to a device that does not include an L2CAP extension layer 27, 37. Hence, if the receive device does not include an L2CAP extension layer 37, then a negative confirmation is returned, i.e. L2CA_ConfigRspNeg. However, where the receive device includes an L2CAP extension layer 37, then the extension layer 37 intercepts the received configuration request and issues a positive confirmation, i.e. L2CA_ConfigRsp. Ideally, the L2CA_ConfigRsp signal includes an inflow parameter that repeats the configuration settings sent by the transmit device. The transmit device 2, upon receipt of such positive configuration response, is then confident that an L2CAP extension layer 37 exists in the receive device, and issues a confirmation of the configuration with a L2CA_ConfigCfm signal. The transmit and receive devices 2, 3 then enter the high-integrity mode.

In the transmit device 2, payload data is received from the application layer 29 into the L2CAP extension layer 27, at step 302. The payload data is suitably divided into one or more L2CAP payload data packets each of a size up to 64 Kb.

Step 303 comprises calculating error control data from the payload data. Here, the L2CAP extension layer 27 of the transmit device 2 calculates an error checking checksum for each payload data packet. The checksum is suitably based on CRC-32 (Ethernet). In the preferred embodiment, a 32-bit polynomial has been chosen for robust error detection. In other embodiments of the invention, other forms of error detection are employed. For example, the checksum is replaced by error control data that allows both error checking and correction (ECC).

Step 304 comprises passing the error control data and the payload data to the L2CAP layer 25. The payload data and the error control data are then transmitted using the lower layers 21-24 of the transmit device 2, to be received at the receive device 3.

At the receive device 3, the payload data is received at the lower layers 31-34, and passed to the L2CAP layer 35, at step 305.

The received payload data is held by the L2CAP extension layer 37, until the corresponding error control data arrives. The error control data will usually arrive immediately after the payload data. Step 306 comprises calculating a checksum from the received payload data. Suitably, step 306 is performed as the payload data is received, such that the checksum calculated from the received payload data is ready to use as soon as the error control data arrives, to reduce latency.

Step 307 comprises checking the received payload data using the received error control data, i.e. by comparing the received checksum against the calculated checksum.

Assuming that no errors are detected, the payload data is passed to the application layer 39 of the receive device 3, at step 308. The error control data is silently discarded by the extension layer 37, since the checksum is of no relevance to the application layer.

If an error is detected in the payload data, or if the error control data is not received within a specified period, then remedial action is taken at step 309. Step 309 suitably comprises initiating a disconnect request, or employing a retry procedure.

FIG. 4 is a schematic diagram showing example data in protocol stack layers 20, 30 of the transmit device 2 and the receive device 3. In the transmit device, application payload data 290 exists in the application layer 29. The example of FIG. 4 assumes that the payload data 290 is relatively long (greater than 64 Kb). The application payload data 290 passes through the L2CAP extension layer 27 to the L2CAP layer 25, to form a series of L2CAP data packets 251,252. The series of L2CAP packets includes a plurality of payload data packets 251 each comprising a section of the application payload data 290. Each of the payload data packets 251 is immediately followed by a corresponding error control data packet 252 that has been generated by the L2CAP extension layer 27. Each L2CAP payload data packet 251 suitably comprises a length field L, a channel identifier field C, and a portion of payload data in the range of 4 to 64 K bytes. Each error control data packet 252 suitably comprises a length field L, a channel ID field C, a symbol S of 32 bits identifying the data in this packet as being error control data, and the checksum itself CS. The payload data packets 251 and the error control data packets 252 are passed through the lower layers 21-24 of the Bluetooth protocol stack, to form baseband packets 220 ready for wireless transmission. The reverse procedure applies in the receive device 3, with each received payload data packet 251 being immediately followed by a corresponding error control data packet 252. If no errors are detected, then the payload data is extracted from the payload data packets 251 and used to re-construct the application payload data 290.

It is preferred that the devices 2, 3 each resume the normal mode whenever a link is disconnected. Conveniently, the high integrity mode is negotiated when establishing a new link, or at any convenient time within an established link prior to sending data in the high integrity mode.

In a particularly preferred implementation of the present invention, the receive device 3 optionally initiates negotiation of the high integrity mode. Advantageously, a receive device 3 that is particularly vulnerable to erroneous data, such as a printer, initiates a negotiation in order to establish a high integrity mode with the transmit device 2, where both devices include the L2CAP extension layer 27, 37.

The high integrity mode is applicable unidirectionally such as from a transmit device to a receive device, and optionally is applicable bidirectionally to provide improved error control for data in both directions between the two devices.

The wireless communication system and error control method described herein have a number of advantages. In particular, error control is improved by providing more robust error checking. Compatibility is maintained with existing applications in higher layers, and with existing hardware or firmware in lower layers. Ideally, the L2CAP extension layer is transparent both from above and from below. A high integrity link is provided using enhanced error control, when two devices are both capable of supporting this feature. However, at other times, operation continues in a normal mode to maintain compatibility with existing applications and devices. Minimal or no adaptation is required to existing applications and devices, and minimal additional control overhead and transmission overhead is introduced.

1. An error control method for use in a Bluetooth wireless communication system that includes a transmit device and a receive device, the transmit device and the receive device each comprising an application layer, an L2CAP extension layer, an L2CAP layer, and one or more lower layers, the method comprising the steps of:
in the transmit device, receiving payload data from the application layer at the L2CAP extension layer; calculating an error control data from the payload data; and passing the payload data and the error control data to the L2CAP layer for transmission to the receive device; and
in the receive device, receiving the payload data and the error control data at the L2CAP layer; checking the received payload data using the received error control data in the L2CAP extension layer; and passing the checked payload data to the application layer.

2. The method of claim 1, wherein the error control data comprises a CRC checksum.

3. The method of claim 1, comprising discarding the error control data, such that the error control data is not passed to the application layer of the receive device.

4. The method of claim 1, comprising, in the transmit device, forming a payload data packet containing payload data received from the application layer; and forming an associated error control data packet containing error control data calculated from the payload data in the payload data packet.

5. The method of claim 4, comprising transmitting the payload data packet immediately followed by the error control data packet.

6. The method of claim 1, comprising the step of negotiating between the transmit device and the receive device, or vice versa, to establish either a normal mode of operation without the calculation of error control data, or a high integrity mode of operation that includes calculation of error control data.

7. The method of claim 1, comprising the step of taking remedial action if no error control data is received at the receive device, or if checking the payload data using the received error control data indicates an error in the payload data.

8. A method of providing a high integrity link in a Bluetooth wireless communication system, the method comprising the steps of:
negotiating a high integrity mode between a transmit apparatus and a receive apparatus;
receiving payload data from an application layer into an L2CAP extension layer, calculating a checksum, and transmitting the checksum and the payload data; and
receiving the payload data and the checksum at an L2CAP extension layer, checking the payload data using the checksum, and passing the payload data to an application layer.

9. The method of claim 8, comprising forming a first L2CAP data packet that contains the payload data, and forming a second L2CAP data packet that contains the checksum.

10. The method of claim 9, comprising transmitting the second L2CAP data packet containing the checksum immediately following the first L2CAP data packet containing the payload data.

11. The method of claim 9, comprising discarding the second L2CAP data packet containing the checksum.

12. A Bluetooth wireless communication system, comprising:
a transmit device having an application layer and an L2CAP layer, and an L2CAP extension layer between the application layer and the L2CAP layer, the L2CAP extension layer being arranged to calculate error control data from payload data; and
a receive device having an application layer and an L2CAP layer, and an L2CAP extension layer between the application layer and the L2CAP layer, the L2CAP extension layer of the receive device being arranged to check received payload data using received error control data.

13. The system of claim 12, wherein the transmit device is arranged to form a first L2CAP data packet containing the payload data, and a second L2CAP data packet containing an error control checksum.

14. The system of claim 13, wherein the transmit device is arranged to transmit the first L2CAP data packet containing the payload data immediately followed by the second L2CAP data packet containing the checksum.

15. The system of claim 12, wherein the receive device is arranged to discard the error control data in the L2CAP extension layer, such that only the payload data is passed to the application layer.

16. The system of claim 12, wherein the receive device is arranged to take remedial action if the error control data is not received, or if the error control data indicates an error in the received payload data.

17. A device adapted for use in a Bluetooth wireless communication system, the device comprising:
an application layer;
an L2CAP layer; and
an L2CAP extension layer between the application layer and the L2CAP layer, the L2CAP extension layer being arranged to form a checksum from payload data received from the application layer for transmission through the L2CAP layer, and being arranged to check payload data received from the L2CAP layer using received checksum data before passing the received payload data to the application layer.
